(19) United States
(12) Patent Application Publication
(10) Pub. No.: US 2022/0271609 A1
(43) Pub. Date: Aug. 25, 2022

(54) ELECTRICAL MACHINE WITH COOLED BUSBARS

(71) Applicant: Robert Bosch GmbH, Stuttgart (DE)

(72) Inventors: Konstantin Lindenthal, Blaichach (DE); Claus-Christian Oetting, Blaichach (DE); Sebastian Hoffmann, Sonthofen (DE); Andreas Herzberger, Remseck Am Neckar (DE); Thomas Bublat, Remseck Am Neckar (DE); Uwe Knappenberger, Muehlacker (DE)

(21) Appl. No.: 17/625,530

(22) PCT Filed: May 29, 2020
(86) PCT No.: PCT/EP2020/064997

§ 371 Date: Jan. 7, 2022

(30) Foreign Application Priority Data
Jul. 11, 2019 (DE) 10 2019 210 308.1

(51) Int. Cl. H02K 5/20; H02K 3/50; H02K 5/15; H02K 9/19

(52) U.S. Cl. CPC H02K 5/203; H02K 3/50; H02K 5/15; H02K 9/19; H02K 2203/09

(57) ABSTRACT

The present invention relates to an electrical machine (1) having a rotor (2) and a stator (3) which are at least partially arranged in a machine housing (4), and also having a cooling jacket (5) for cooling the stator (3), a plurality of first cooling ducts (6), which run parallel in relation to one another, in particular in an axial direction with respect to the stator axis, for guiding a cooling medium run through said cooling jacket, wherein the machine housing (4) has at least one end plate (7), which is connected to the cooling jacket (5), for supporting a rotor shaft (8) of the rotor (2), wherein a plurality of second cooling ducts (9) which each connect two, in particular adjacent, first cooling ducts (6) to one another in terms of flow are formed on the end plate (7), wherein the second cooling ducts (9) together with the first cooling ducts (6) produce a coolant path, which is in particular of meandering or serpentine design, through the electrical machine (1), and wherein at least one busbar (10) which is electrically connected to a stator winding (14) of the stator (3) runs on the end plate (7), characterized in that the busbar (10) has a main section (11) and at least one cooling lug (12) which extends from the main section (11), wherein the cooling lug (12) engages into a housing recess (13) of the end plate (7), which housing recess is formed directly adjacent to one of the second cooling ducts (9).

### BACKGROUND

The present invention relates to an electrical machine. The electrical machine in particular has cooled busbars.

Electrical machines are known from the prior art, for example from EP 1 401 089 A1. Conventional electrical machines comprise a rotor and a stator, wherein the stator has a stator winding in which a magnetic field can be generated, in order to drive the rotor. For the energization of the stator winding, busbars are provided which, in service, undergo heat-up as a result of their electrical resistance. This heat is dissipated, for example, by means of heat-conducting pads. To this end, in many cases, part of a housing of the electrical machine, or the entire housing of the electrical machine, is formed of a metallic material, wherein said heat-conducting pads evacuate heat from the busbar to said metallic housing.

### SUMMARY

The electrical machine according to the invention permits the efficient cooling of busbars. In particular, optimum cooling is possible where a housing of the electrical machine is not formed of a metallic material and/or is formed of a poor thermally-conductive material. Optimum cooling is achieved, wherein the busbars have cooling lugs which evacuate heat directly to a cooling duct, and wherein a cooling medium can flow in the cooling duct. In this manner, a secure and reliable evacuation of heat from the busbars can be achieved.

The electrical machine according to the invention has a rotor and a stator. The rotor and stator are at least partially arranged in a machine housing. At least the stator has a stator winding. The rotor can be configured in an arbitrary manner, and is specifically designed to cooperate with the stator. The stator can drive the rotor accordingly.

The electrical machine further has a cooling jacket for cooling the stator. First cooling ducts, for the conveyance of a cooling medium, run through the cooling jacket. The first cooling ducts are preferably oriented in parallel, in particular in an axial direction with respect to the stator axis. The cooling medium can be a thermally conductive fluid, for example water.

The machine housing comprises an end plate. The end plate is connected to the cooling jacket. Advantageously, a plurality of end plates can be provided, which are connected to the cooling jacket. A rotor shaft of the rotor is supported on the end plate. The end plate moreover has second cooling ducts. The first cooling ducts and the second cooling ducts are particularly coupled in a fluidically connective manner, wherein each second cooling duct fluidically connects two first, and preferably adjoining cooling ducts. By means of the first cooling ducts and the second cooling ducts, heat can be evacuated from the electrical machine and, in particular, the stator can be cooled by means of the cooling ducts. In particular, the first cooling ducts and the second cooling ducts constitute a continuous coolant path through the electrical machine. This coolant path is preferably configured with a meander-shaped or serpentine design.

At least one busbar runs along the end plate. The busbar is electrically connected to a stator winding of the stator. In particular, it is thus possible for the stator winding to be energized by means of the busbar.

It is provided that the busbar has a main section and at least one cooling lug, which extends from the main section. The cooling lug is arranged in the machine housing such that it engages in a housing recess of the end plate. The housing recess is configured directly adjacently to one of the second cooling ducts. A heat transfer is thus permitted between the cooling medium which flows in the second cooling duct and the busbar, in particular the cooling lug of the busbar. As a result, the cooling lug can cool the busbar, wherein heat is evacuated from the busbar by means of the cooling medium.

By such an arrangement and configuration of the busbar, it is achieved that a large surface area is provided for the evacuation of heat from the busbar to the cooling medium. By means of this surface area, the busbar can be effectively cooled. As a result, under conditions of equal electrical loading, i.e. at an equal current, the cross-section of the busbar can be reduced. Accordingly, costs of the electrical machine can be reduced, in comparison with electrical machines from the prior art. Moreover, a reduction of the cross-section of the busbar permits a saving of weight. Alternatively, the effective cooling of the busbar permits higher electric currents to flow in a busbar of equal cross-section. Moreover, heat-conducting pads of the type employed in the prior art are not required, thereby reducing the complexity of installation, and consequently also installation costs. The advantage of effective cooling is particularly achieved, wherein use is made of an existing cooling circuit of the electrical machine. This is employed for the cooling of the electrical machine, particularly of the stator and, in a particularly preferred manner, of an overhang winding of the stator, and is thus already present in the electrical machine. Alternatively, there is an option for the constitution of a separate cooling circuit, which is independent of the above-mentioned circuit, for the cooling of busbars. As a result, it is not necessary to adopt specific measures for heat evacuation. In particular, cost-intensive hybrid structures, particularly metal elements arranged in plastic, can thus be omitted.

Advantageously, the cooling jacket is a subsection of the stator, or a part of the machine housing. In particular, the cooling jacket can be configured in a stator plate stack. If the cooling jacket is part of the machine housing, the cooling jacket thus encloses the stator, at least in part and, in particular, completely. The cooling jacket particularly encloses the stator in a circumferential direction, about an axis of rotation of the electrical machine. The stator is advantageously supported by the cooling jacket.

It is preferably provided that the busbar has two cooling lugs. Each cooling lug is respectively arranged in a dedicated housing recess of the end plate. One of the second cooling ducts runs between the two housing recesses, such that the two housing recesses are configured on either side of one of the second cooling ducts. By means of the arrangement of cooling lugs on either side of the cooling duct, the surface area from which heat originating from the busbar can be transmitted to the cooling medium is expanded. An improved cooling capacity is delivered as a result. Particularly advantageously, the two cooling lugs extend in parallel with one another.

Advantageously, a thermally-conductive material is introduced between the cooling lug and the end plate. The thermally-conductive material can particularly be a thermally-conductive adhesive. This results in a further improvement of heat transfer between the busbar and the cooling medium which flows in the second cooling ducts.

It is also advantageously provided that an electrically-insulating material is introduced between the cooling lug and the end plate. In particular, this is an electrically-insulating adhesive. Particularly advantageously, the adhesive can be both electrically-insulating and thermally-conductive. If the adhesive is electrically-insulating, for example, housing components of metal construction can be employed, which permit optimum thermal conduction whereas, as the same time, the risk of a short-circuit across the busbar is minimized. Alternatively or additionally to the adhesive, the insulating material can also be configured in the form of a protective lacquer and/or an insert.

Advantageously, the main section of the busbar is configured integrally with the cooling lug of the busbar. Particularly advantageously, the busbar is produced in the form of a stamped and bent part. The busbar can thus be produced in a simple and cost-effective manner wherein, moreover, in this manner, the different sections, i.e. the main section and the cooling lug, can be constituted simply and with limited complexity.

In an alternative configuration, the main section and the cooling lug are separate elements. By means of a joining method, the cooling lug and the main section are interconnected. Particularly advantageously, the joining method employed permits an optimum heat transfer between the cooling lug and the main section. In this manner, it is achieved that the cooling lug can be reliably employed for heat evacuation from the main section and from the entire busbar. By the separate configuration of the cooling lug and the main section, and the subsequent joining of the two components, any arbitrary design of busbars can be implemented in a simple and cost-effective manner. Greater flexibility in the configuration and design of the busbar is provided accordingly.

It is preferably provided that the main section and the cooling lug are connected in a materially-bonded manner. This is particularly achieved by welding and/or soldering. The main section and the cooling lug can also be bonded by means of a friction-locked connection. A friction-locked connection can particularly be achieved by means of a press-fit. Finally, it is alternatively or additionally provided that the main section and the cooling lug are bonded in a positive-locking manner. This is particularly advantageously achieved by means of a riveted connection. All these different forms of connection permit a simple and cost-effective connection of the main section to the cooling lug, thereby permitting heat transfer between the main section and the cooling lug. It is thus achieved that the cooling lug can evacuate heat from the main section and from the entire busbar.

Particularly advantageously, the stator winding is a three-phase winding. Accordingly, three busbars are present, each of which is respectively electrically connected to one phase of the stator winding. All these busbars are configured as described above, i.e. all these busbars comprise a main section and at least one cooling lug. Heat can thus be evacuated from the busbars in an optimum manner.

The cooling jacket and/or the end plate are preferably formed of a metallic material. Alternatively or additionally, the cooling jacket and the end plate can be formed of a plastic material. If metallic materials are employed, thermal conductivity is improved accordingly. The constitution of elements from plastic, in turn, permits a flexible configuration and cost-effective production. Where the end plate is constituted of a plastic material, as an alternative arrangement for the fitting of the busbar to the end plate, it is also possible for the busbar, together with the cooling lug, to be moulded into the end plate.

The cooling jacket is preferably configured in a hollow cylindrical form. The first cooling duct is arranged along a central axis of the hollow cylindrical form, wherein the end plate closes the cooling jacket at an end face. In particular, in this manner, an S-shaped passage of the cooling medium through the cooling jacket and the end plate can be achieved.

It is particularly preferred that each cooling lug is configured such that the latter extends in parallel with a central axis of the rotor.

### BRIEF DESCRIPTION OF THE DRAWINGS

Exemplary embodiments of the invention are described in detail hereinafter, with reference to the attached drawing. In the drawing:

FIG. 1 shows a schematic representation of an electrical machine according to one exemplary embodiment of the invention;

FIG. 2 shows a schematic detailed view of the electrical machine according to the exemplary embodiment of the invention;

FIG. 3 shows a schematic sectional view of an end plate of the machine housing of the electrical machine;

FIG. 4 shows a schematic sectional view of at least one subsection of the electrical machine; and

FIG. 5 shows a schematic detailed view of a subsection of a busbar of the electrical machine, according to the exemplary embodiment of the invention.

### DETAILED DESCRIPTION

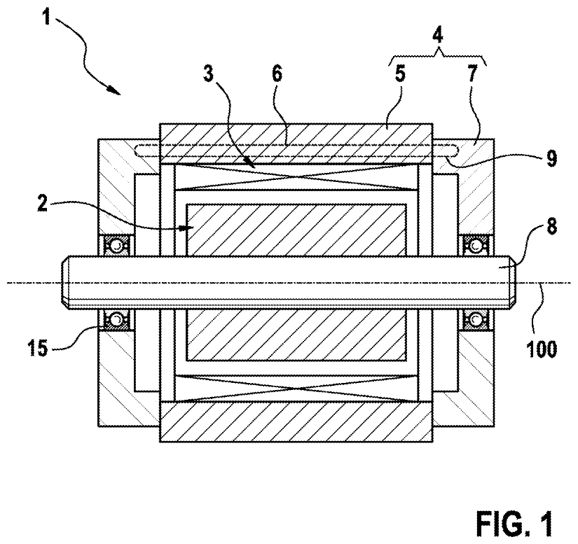

FIG. 1 shows a schematic representation of an electrical machine 1 according to one exemplary embodiment of the invention. The electrical machine 1 has a rotor 2 and a stator 3. The rotor 2 comprises a rotor shaft 8, which is rotatable about a central axis 100.

The rotor 2 is driveable by means of the stator 3. It is provided that the stator 3 can be cooled by means of cooling ducts 6, 9. The cooling ducts 6, 9 are arranged in a machine housing 4 of the electrical machine 1.

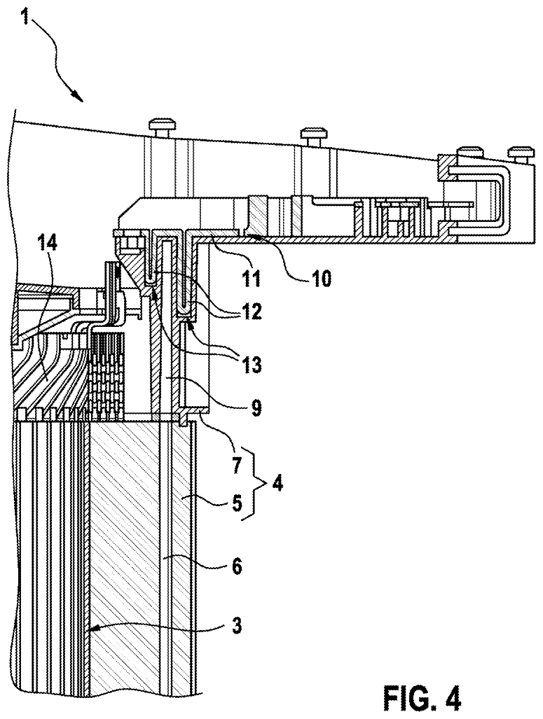

The machine housing 4 thus comprises a cooling jacket 5 and at least one end plate 7 for supporting the rotor shaft 8, wherein two end plates are represented in FIG. 1. Alternatively, the cooling jacket 5 can also be a part of the stator 3. The cooling jacket 5 is configured with a hollow cylindrical form 5, and additionally has a plurality of first cooling ducts 6, each of which extends in parallel with a central axis of the hollow cylindrical form. A fluid can flow in the first cooling ducts, particularly for the cooling of a stator winding 14 (see FIG. 4).

The end plates 7 also have cooling ducts, which are described hereinafter as second cooling ducts 9. Each of the second cooling ducts 9 connects two, for example adjoining first cooling ducts 6 to one another, such that the second cooling ducts 9, in combination with the first cooling ducts 6, constitute a coolant path through the electrical machine 1 which is configured, for example, with a meander-shaped or serpentine design. To this end, for example, a flow diversion arrangement is configured in each of the second cooling ducts 9.

The rotor shaft 8 is supported by means of bearings 15 on the end plates 7. Each end plate is fitted to an end face of the hollow cylindrically-shaped cooling jacket 5.

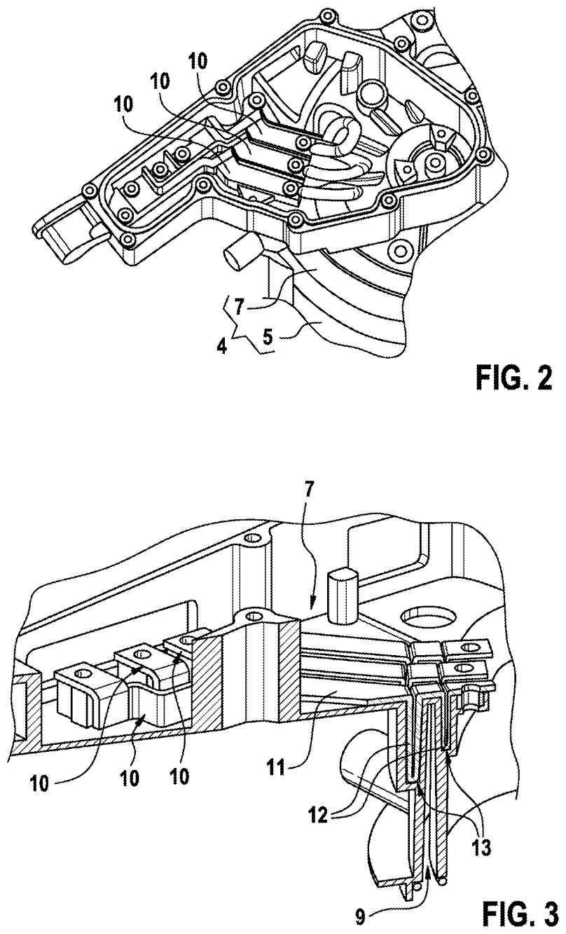

FIG. 2 shows a schematic representation of a profile of three busbars 10. These busbars 10 are electrically connected to the stator winding 14 (see FIG. 4). Thus, by the energization of the busbars 10, energization of the stator winding 14 can be executed. The busbars 10, in particular, are arranged on the end plate 7.

FIG. 3 shows a schematic detailed view of the end plate 7. It is shown that the end plate 7, on either side of the second cooling ducts 9, has housing recesses 13. Cooling lugs 12, which extend from a main section 11 of the busbars 10, engage in these housing recesses 13. It is particularly provided that the busbar is produced in the form of a stamped and bent part. The cooling lugs 12 can thus be produced in a simple manner, with limited complexity. At the same time, an optimum heat transfer between the main section 11 and the cooling lug 12 is permitted.

By the direct arrangement of the housing recesses on one of the second cooling ducts 9, and the arrangement of cooling lugs 12 on either side of the second cooling ducts 9, a large surface area is provided, by means of which heat transfer from the busbar 10 to the cooling medium within the second cooling duct is permitted. The busbar 10 can be effectively cooled as a result. This permits either the conduction of higher currents than would be possible in the absence of such cooling or, alternatively, the configuration of the busbars 10 with a smaller cross-section. By means of the housing recesses 13, the busbars 10 can be fitted in a simple manner, with limited complexity.

For the improvement of heat transfer, it is advantageously provided that a thermally-conductive material is introduced in the housing recesses 13 between the cooling lug 12 and the end plate 7. In particular, this can be a thermally-conductive adhesive. Heat can thus be evacuated in an optimum manner from the busbars 10, particularly from the cooling lugs 12 of the busbars 10, via the end plate 7 to the cooling medium within the second cooling channels 9.

FIG. 4 shows a schematic sectional representation of at least one section of the electrical machine 1. In particular, the coupling of one of the first cooling channels 6 to one of the second cooling channels 9 is represented in FIG. 4. It is moreover represented that the cooling jacket 5 extends about the stator 3. The stator 3, in turn, has the stator winding 14, which is electrically contact-connected by means of the busbars 10. In particular, this is a three-phase stator winding 14, such that each of the busbars 10 is provided for the energization of one phase of the stator winding 14.

A cooling medium which flows through the first cooling duct 6 and the second cooling duct 9 automatically reaches that region of the second cooling duct 9 which is enclosed by the cooling lugs 12. Alternatively, in the event of the presence of only one remaining cooling lug 12, the cooling medium in the corresponding second cooling duct 9 can be streamed past the remaining cooling lug 12. In each case, a heat transfer between the cooling lug 12 and the cooling medium can be executed, such that the busbar 10 is cooled.

The cooling jacket 5 and the end plate 7 can be formed of a metallic material and/or of plastic. A metallic material, in particular, permits a superior conductivity wherein, on the grounds of the arrangement of the busbar 10 along one of the second cooling ducts 9, an optimum evacuation of heat by means of the cooling medium is permitted. If the end plate is formed of a metallic material, it is thus provided that an electrically-insulating material is arranged between the end plate 7 and the busbar 10. In particular, this can be an electrically-insulating adhesive and/or a protective lacquer and/or an insert.

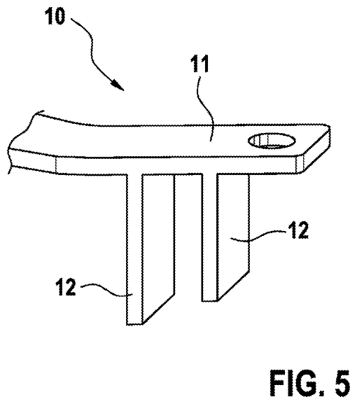

FIG. 5 shows a schematic partial view of the busbar 10. This has a main section 11, together with two cooling lugs 12 which are contiguous thereto. The cooling lugs 12 and the main section 11 can be configured integrally wherein, in this case, the busbar 10 is advantageously a stamped and bent part, as particularly represented in FIG. 3. Alternatively, the cooling lugs 12 can be separate elements, which are connected to the main section 11 by means of a joining method. A method of this type can particularly be a mechanical method, such as riveting and/or press-fitting or, alternatively, a connection between the main section 11 and the cooling lugs 12 can be constituted by means of a thermal method, such as soldering and/or welding.

The busbars 10 can thus be produced and fitted in a simple and cost-effective manner. At the same time, the busbars 10 permit the secure and reliable evacuation of heat via the cooling medium which flows through the first cooling ducts 6 and the second cooling ducts 9.

1. An electrical machine (1) having a rotor (2) and a stator (3),
which are at least partially arranged in a machine housing (4), and having a cooling jacket (5) for cooling the stator (3), through which a plurality of mutually-parallel first cooling ducts (6) run for the conveyance of a cooling medium,
wherein the machine housing (4) has at least one end plate (7) for supporting a rotor shaft (8) of the rotor (2),
wherein a plurality of second cooling ducts (9) are configured on the end plate (7), each of which connects two first cooling ducts (6) in a fluidically connective manner,
wherein the second cooling ducts (9) and the first cooling ducts (6) constitute a coolant path through the electrical machine (1), and
wherein at least one busbar (10) runs along the end plate (7) and is electrically connected to a stator winding (14) of the stator (3),
wherein
the busbar (10) has a main section (11) and at least one cooling lug (12) that extends from the main section (11), wherein the cooling lug (12) engages in a housing recess (13) of the end plate (7) that is configured directly adjacently to one of the second cooling ducts (9).

2. The electrical machine (1) as claimed in claim 1, wherein the cooling jacket (5) is a subsection of the stator (3).

3. The electrical machine (1) as claimed in claim 1, wherein the busbar (10) has two cooling lugs (12), each of which is respectively arranged in a dedicated housing recess (13), wherein the two housing recesses (13) are configured on either side of one of the second cooling ducts (9).

4. The electrical machine (1) as claimed in claim 1, wherein a thermally-conductive material is introduced between the cooling lug (12) and the end plate (7).

5. The electrical machine (1) as claimed in claim 1, wherein an electrically-insulating material is introduced between the cooling lug (12) and the end plate (7).

6. The electrical machine (1) as claimed in claim 1, wherein the main section (11) of the busbar (10) is configured integrally with the cooling lug (12) of the busbar (10).

7. The electrical machine (1) as claimed in claim 1, wherein the main section (11) of the busbar (10) and the cooling lug (12) of the busbar (10) are separate elements that are interconnected.

8. The electrical machine (1) as claimed in claim 7, wherein the main section (11) and the cooling lug (12) are connected in a materially-bonded manner, and/or are connected in a friction-locked manner, and/or are connected in a positive-locking manner.

9. The electrical machine (1) as claimed in claim 1, wherein the stator winding (14) is a three-phase winding, wherein three busbars (10) are present, each of which is respectively electrically connected to one phase of the stator winding (14).

10. The electrical machine (1) as claimed in claim 1, wherein the cooling jacket (5) and/or the end plate (7) is formed of a metallic material and/or of a plastic.

11. The electrical machine (1) as claimed in claim 1, wherein the cooling jacket (5) is configured in a hollow cylindrical form, wherein the first cooling ducts (6) are arranged along a central axis of the hollow cylindrical form, and wherein the end plate (7) closes the cooling jacket (5) at an end face.

12. The electrical machine (1) as claimed in claim 1, wherein the busbar (10) and the cooling lug (12) are moulded into the end plate (7).

13. The electrical machine (1) as claimed in claim 1, wherein the plurality of mutually-parallel first cooling ducts (6) run in an axial direction with respect to an axis of the stator.

14. The electrical machine (1) as claimed in claim 1, wherein each of the plurality of second cooling ducts (9) connects two adjoining first cooling ducts (6).

15. The electrical machine (1) as claimed in claim 1, wherein the coolant path through the electrical machine (1) is configured with a meander shape or a serpentine shape.

16. The electrical machine (1) as claimed in claim 2, wherein the cooling jacket (5) is a subsection of a stator plate stack, or a part of the machine housing (4) that at least partially encloses the stator (3).

17. The electrical machine (1) as claimed in claim 4, wherein the thermally-conductive material is a thermally-conductive adhesive.

18. The electrical machine (1) as claimed in claim 5, wherein the electrically-insulating material is an electrically-insulating adhesive and/or a protective lacquer and/or an insert.

19. The electrical machine (1) as claimed in claim 6, wherein the busbar (10) is a stamped and bent part.

20. The electrical machine (1) as claimed in claim 8, wherein the materially-bonded manner includes solder and/or welding, wherein the friction-locked manner includes press-fitting, and wherein the positive-locking manner includes a riveted connection.
